(19) United States
(12) Patent Application Publication
(10) Pub. No.: US 2013/0001392 A1
(43) Pub. Date: Jan. 3, 2013

(54) Pad with Sucking Discs

(76) Inventors: Sheng-Chi Lin, Tainan City (TW); Yuan-Song Tsai, Tainan City (TW)

(21) Appl. No.: 13/171,532

(22) Filed: Jun. 29, 2011

(51) Int. Cl. F16B 47/00; F16M 13/00

(52) U.S. Cl. 248/346.03

(57) ABSTRACT

A pad with sucking discs includes a lower sucking disc and an upper sucking disc. The lower sucking disc is in an arc-shape with a protuberant center, while the upper sucking disc is in an arc-shape with a concave center. The lower sucking disc is adapted to suck on a platform for placing things such as a table, floor, etc. The upper sucking disc is adapted for placing objects such as beverage bottles, bowls, dishes or cups, etc. When an object is placed on the upper sucking disc, the pad is sucked to combine with the object and the platform respectively by a pressure applied, so that the objects placed on the pad do not easily fall off because of impact from an external force.

### BACKGROUND OF THE INVENTION

1. Field of the Invention

The present invention relates to a pad with sucking discs and, more particularly, to a pad for placing beverage bottles or cans, bowls, dishes, or cups with anti-slipping and positioning functions.

2. Description of the Related Art

Beverage bottles or cans, cups, bowls, dishes, or water containers used by common households can easily fall due to carelessness. It is especially troublesome for households with infants. With the improvement on living standard and fast food culture becoming more popular, office workers and students often place beverage bottles, cans, or cups on tables. However, common beverage bottles, cans, or cups easily fall due to impact from external force, resulting in drink being spilled out which is troublesome and inconvenient.

Cup holders found in the markets are used for holding or placing cups, but the cups still fall easily because of impact from external force. Therefore, the problem needs to be addressed and improvement is needed.

### BRIEF SUMMARY OF THE INVENTION

Thus, an objective of the present invention is to provide a pad with sucking discs to improve the aforementioned problem. The pad of the present invention can suck and fix on platforms for placing things such as tables or floors, etc.; the pad can also be used for placing objects such as beverage bottles or cans, bowls, dishes, or cups, so that beverage bottles or cans, bowls, dishes, or cups do not fall easily because of impact from external force. Furthermore, the pad of the present invention can be easily detached from the object being placed and, therefore, can be used repeatedly.

To achieve this and other objectives, a pad with sucking discs of the present invention includes a lower sucking disc and an upper sucking disc. The lower sucking disc includes a lower center and a lower periphery extending downwards from the lower center. The lower sucking disc is formed in arc-shape with the protruding lower center, and a lower space having flexible compression characteristic is defined inside the lower sucking disc. The upper sucking disc includes an upper center and an upper periphery extending upwards from the upper center. The upper center of the upper sucking disc is integrally combined with the lower center of the lower sucking disc, and the upper periphery is spaced from the lower periphery in a vertical direction. The upper sucking disc is formed in arc-shape with the concave upper center, and an upper space having flexible compression characteristic is defined inside the upper sucking disc. Further, a through-hole extends through the upper center of the upper sucking disc and the lower center of the lower sucking disc and communicates the lower space with the upper space. The lower sucking disc is adapted to suck on platforms for placing things such as tables, floor, etc. The upper sucking disc is adapted for placing objects such as beverage bottles, bowls, dishes or cups, etc., so that the object placed on the pad do not fall off because of impact from external force. In addition, simply lift up a small portion of the lower sucking disc to let air flow from the lower sucking disc into the upper sucking disc through the through-hole, allowing the object placed on the pad to be detached from the upper sucking disc easily. Thus, the pad provides solutions for fixing and detaching the objects such as beverage bottles, bowls, dishes, or cups, etc. easily and conveniently.

In a preferred form, the through-hole extends through the upper center and the lower center in the vertical direction. The upper sucking disc has an outer diameter smaller than that of the lower sucking disc. An annular surrounding wall extends upward from the lower periphery of the lower sucking disc of the pad, and the surrounding wall surrounds the upper sucking disc and has a vertical height larger than that of the upper sucking disc.

The present invention will become clearer in light of the following detailed description of illustrative embodiments of this invention described in connection with the drawings.

### DESCRIPTION OF THE DRAWINGS

The illustrative embodiments may best be described by reference to the accompanying drawings where:

FIG. 1 is a perspective view of a pad with sucking discs in accordance with a first embodiment of the present invention.

FIG. 2 is a cross-sectional view of the pad of FIG. 1.

FIG. 3 is a perspective view showing a dish placed on an upper sucking disc of the pad of FIG. 1.

FIG. 4 is a cross-sectional view of the pad and the dish of FIG. 3.

FIG. 5 is a perspective view of a pad with sucking discs in accordance with a second embodiment of the present invention.

FIG. 6 is a cross-sectional view showing a bottle placed on an upper sucking disc of the pad of FIG. 5.

### DETAILED DESCRIPTION OF THE INVENTION

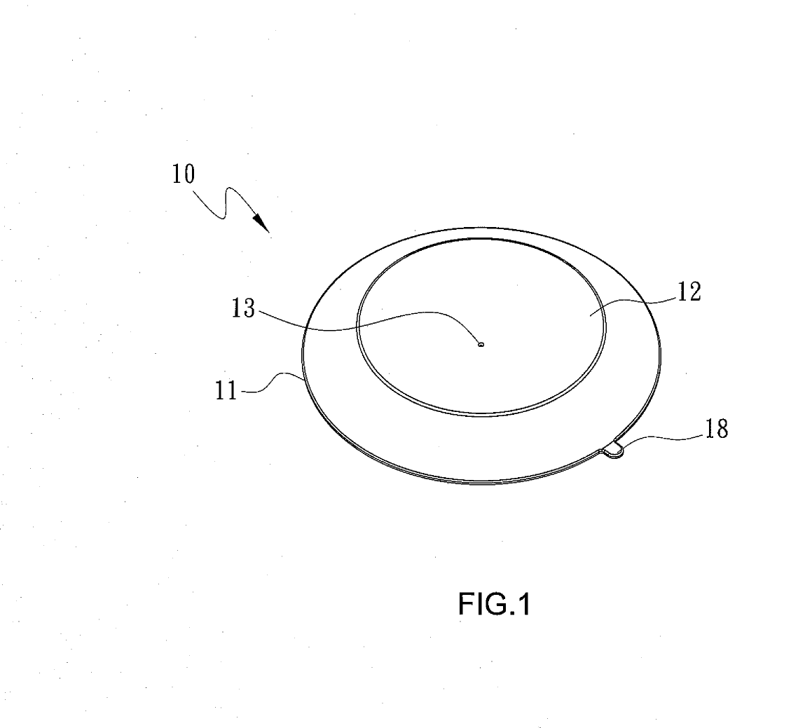

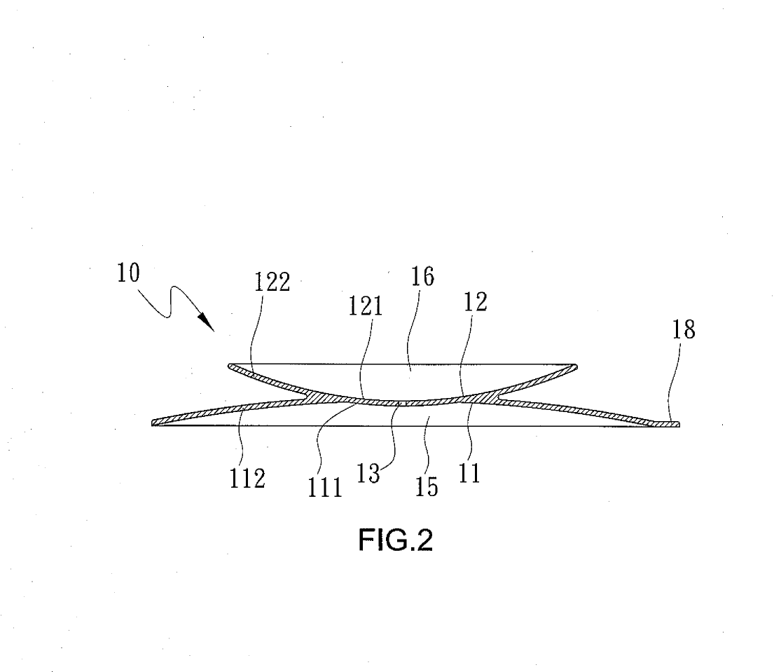

A pad with sucking discs according to a first embodiment of the present invention is shown in FIGS. 1 through 4 of the drawings and generally designated 10. The pad 10 can be made from a soft material such as a synthetic foam rubber or multi-layered laminated fabric. The pad 10 includes a lower sucking disc 11 and an upper sucking disc 12. The lower sucking disc 11 includes a lower center 111 and a lower periphery 112 extending downwards from the lower center 111. The lower sucking disc 11 is formed in arc-shape with the protruding lower center 111, and a lower space 15 with flexible compression characteristic is defined inside the lower sucking disc 11. The outer diameter of the upper sucking disc 12 is smaller than that of the lower sucking disc 11. The upper sucking disc 12 includes an upper center 121 and an upper periphery 122 extending upwards from the upper center 121. The upper center 121 of the upper sucking disc 12 is integrally combined with the lower center 111 of the lower sucking disc 11. The upper periphery 122 of the upper sucking disc 12 is spaced from the lower periphery 112 of the lower sucking disc 11 in a vertical direction. The upper sucking disc 12 is formed in arc-shape with the concave upper center 121, and an upper space 16 with flexible compression characteristic is defined inside the upper sucking disc 12. A through-hole 13 extends through the upper center 121 of the upper sucking disc 12 and the lower center 111 of the lower sucking disc 11 in the vertical direction and communicates the lower space 15 with the upper space 16.

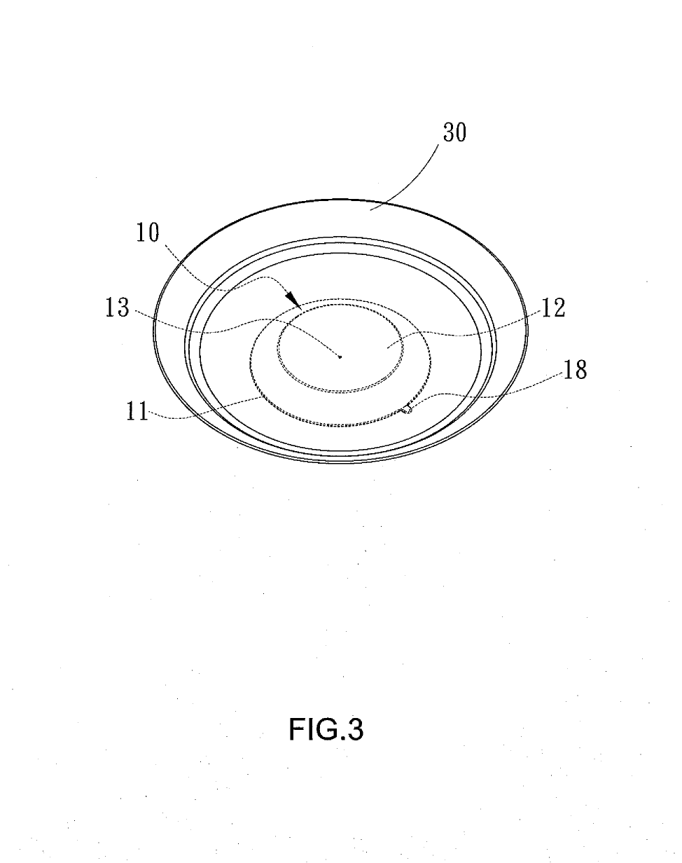

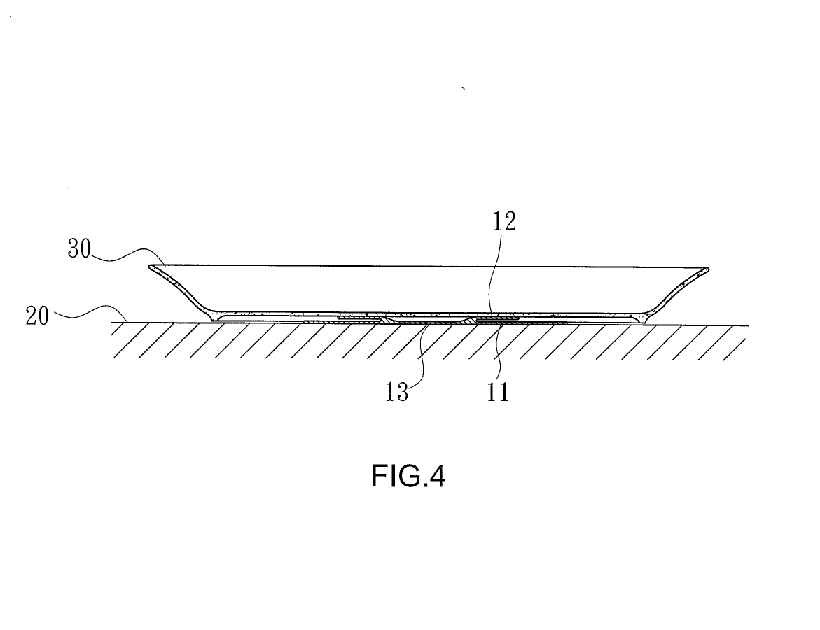

FIGS. 3 and 4 show the pad 10 placed on a platform 20 (such as a table or floor, etc.) and a bottom of an object 30 (such as a cup, bowl, dish, bottle, etc.) placed on the pad 10. In use, a user places a lower surface of the lower sucking disc 11 of the pad 10 on the platform 20. With the lower space 15 having flexible compression characteristic between the lower sucking disc 11 and the platform 20, air in the lower space 15 is discharged when the lower sucking disc 11 is pressed downward, so that the lower sucking disc 11 of the pad 10 produces sucking effect and, therefore, can be fixed on the platform 20. On the other hand, the object 30 is placed on the upper sucking disc 12 of the pad 10. With the upper space 16 having flexible compression characteristic between the upper sucking disc 12 and the object 30, air in the upper space 16 is discharged when the object 30 is pressed downward against the upper sucking disc 12, so that the bottom of the object 30 is sucked and fixed on the upper sucking disc 12. Thus, the object 30 is fixed steadily on the platform 20 through the pad 10. Further, simply lift up a small portion of the lower sucking disc 11 to let air flow from the lower sucking disc 11 into the upper sucking disc 12 through the through-hole 13, allowing the object 30 to be detached from the upper sucking disc 12. In other words, because of the design of the through-hole 13 extending through the upper center 121 of the upper sucking disc 12 and the lower center 111 of the lower sucking disc 11, the sucking effect of the lower sucking disc 11 is eliminated by lifting up the lower sucking disc 11; at the same time, the sucking effect of the upper sucking disc 12 is also eliminated. Thus, the object 30 can be easily detached from the upper sucking disc 12.

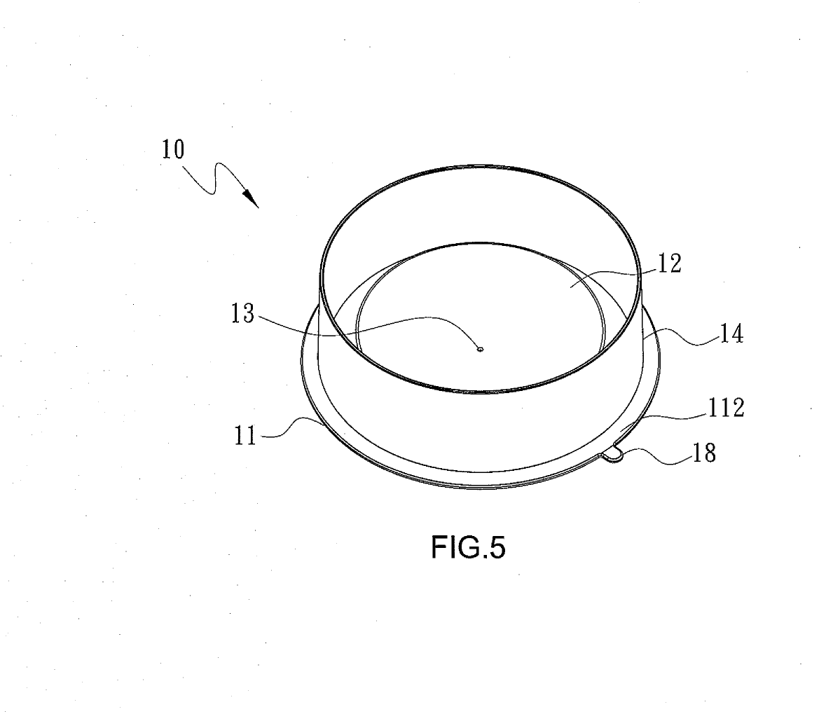

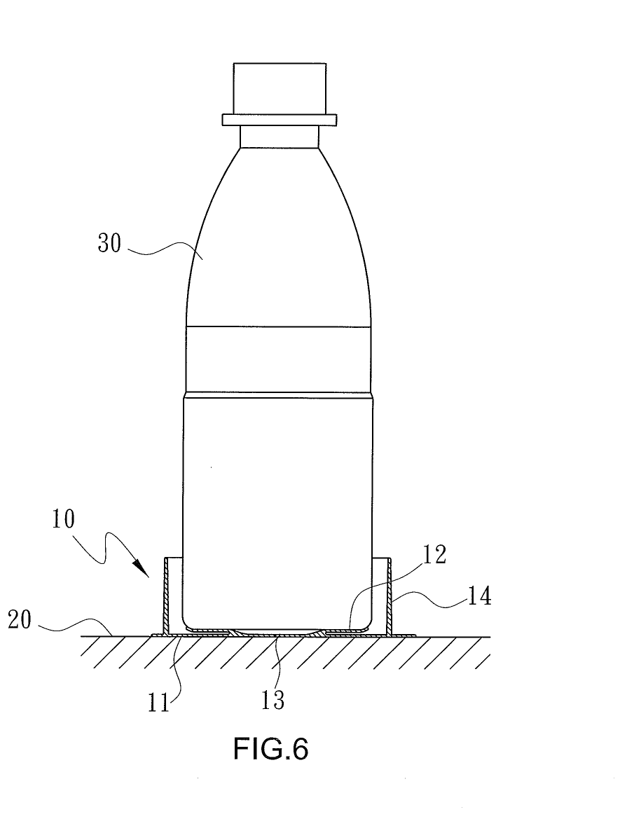

Now that the basic teachings of the present invention have been explained, many extensions and variations will be obvious to one having ordinary skill in the art. The pad 10 shown in FIGS. 5 and 6 is a modification of that shown in FIGS. 1 through 4. In the embodiment, pad 10 includes lower and upper sucking discs 11 and 12 that are similar to lower and upper sucking discs 11 and 12 in the first embodiment. Description of the parts of pad 10 shown in FIGS. 5 and 6 identical to those shown in FIGS. 1 through 4 is omitted. In particular, an annular surrounding wall 14 extends upward from the lower periphery 112 of the lower sucking disc 11 of the pad 10. The surrounding wall 14 surrounds the upper sucking disc 12 and has a vertical height larger than that of the upper sucking disc 12. When object 30 such as a bottle, a beverage can, a cup, etc., is placed on the upper sucking disc 12, the surrounding wall 14 surrounds the object 30. Therefore, it is even less easily for the object 30 to fall due to impact from external force. Furthermore, the surrounding wall 14 can be formed in circular, rectangular or other geometric shape to fit the object 30.

It can be appreciated that the pad 10 of the present invention is not limited to be used for fixing bottles, cans, or cups, etc. The pad 10 can also be applied for stationery or other objects for fixing purpose.

Thus since the invention disclosed herein may be embodied in other specific forms without departing from the spirit or general characteristics thereof, some of which forms have been indicated, the embodiments described herein are to be considered in all respects illustrative and not restrictive. The scope of the invention is to be indicated by the appended claims, rather than by the foregoing description, and all changes which come within the meaning and range of equivalency of the claims are intended to be embraced therein.

1. (canceled)

2. A pad comprising:
a lower sucking disc adapted for sucking on a platform;
an upper sucking disc adapted for placing a bottom of an object, with the lower sucking disc including a lower center and a lower periphery extending downwards from the lower center, with the lower sucking disc formed in an arc-shape with the protruding lower center, with a lower space having a flexible compression characteristic defined inside the lower sucking disc, with the upper sucking disc including an upper center and an upper periphery extending upwards from the upper center, with the upper center of the upper sucking disc integrally combined with the lower center of the lower sucking disc, with the upper periphery spaced from the lower periphery in a vertical direction, with the upper sucking disc formed in an arc-shape with the concave upper center, with an upper space having a flexible compression characteristic defined inside the upper sucking disc, with a through-hole extending through the upper center of the upper sucking disc and the lower center of the lower sucking disc and communicating the lower space with the upper space, with the through-hole extending through the upper center and the lower center in the vertical direction, with the upper sucking disc having an outer diameter smaller than that of the lower sucking disc, with an annular surrounding wall extending upward from the lower periphery of the lower sucking disc of the pad, with the surrounding wall surrounding the upper sucking disc and having a vertical height larger than that of the upper sucking disc; and
a tab integrally formed with and extending radially outwardly of the lower periphery of the lower sucking disc for lifting to let air flow to the lower sucking disc.

3. The pad according to claim 2, with the surrounding wall being in a circular shape.

4. The pad according to claim 2, with the upper and lower sucking discs made from a synthetic foam rubber or a multi-layered laminated fabric.

5. The pad according to claim 2, with the annular surrounding wall having an outer diameter smaller than that of the lower sucking disc.
